(19) United States
(12) Patent Application Publication
(10) Pub. No.: US 2010/0070856 A1
(43) Pub. Date: Mar. 18, 2010

(54) Method for Graphical Visualization of Multiple Traversed Breadcrumb Trails

(75) Inventors: Stefan Behl, Holzgerlingen (DE); Stephan Hesmer, Gaertringen (DE); Timo Kussmaul, Boeblingen (DE); Andreas Nauerz, Boeblingen (DE)

Correspondence Address: KING & SPALDING, 1180 PEACHTREE ST., ATLANTA, GA, 30309, US

(73) Assignee: International Business Machines Corporation, Armonk, NY (US)

(21) Appl. No.: 12/209,801

(22) Filed: Sep. 12, 2008

(51) Int. Cl. G06F 3/00

(52) U.S. Cl. 715/704

(57) ABSTRACT

A method for graphical visualization of multiple clickstreams traversed by a user that involves initiating a clickstream session in response to a user log-in and intercepting and storing all navigation interactions of the user during the clickstream session by a clickstream recorder component. In response to the user's request, the stored navigation interactions of the user for the clickstream session are analyzed by a clickstream analyzer to identify segments comprising interconnected nodes sequentially traversed by the user in a single navigation path during the session and to distinguish segments comprising nodes unrelated to other nodes traversed during the session. A graphic depiction of the identified segments comprising the interconnected nodes sequentially traversed by the user in a single navigation path during the session is presented to the user by a clickstream visualizer.

### CROSS-REFERENCE TO RELATED APPLICATION

This application is related to commonly assigned applications Attorney Docket No. DE9 2008 0172 entitled “METHOD FOR AUTOMATICALLY CONSTRUCTING PAGEFLOWS BY ANALYZING TRAVERSED BREADCRUMBS”; Attorney Docket No. DE9 2008 0173 entitled “METHOD FOR AUTOMATICALLY CONSTRUCTING MEGAFLOWS AND SUPERFLOWS BY ANALYZING TRAVERSED BREADCRUMBS OF ENTIRE COMMUNITIES”; and Attorney Docket No. DE9 2008 0174 entitled “AN EXTENDABLE RECOMMENDER FRAMEWORK FOR WEB-BASED SYSTEMS”, each filed simultaneously herewith and each of which is incorporated herein by this reference.

### BACKGROUND OF THE INVENTION

1. Field of the Invention

This invention relates to web portals and more particularly to a method for graphical visualization of multiple clickstreams traversed by a user.

2. Description of Background

FIG. 1 is a schematic system view of an example of a portal server implementing an existing art portal. A prior art portal such as WebSphere™ portal by IBM™ is built by a complex functionality implemented on a network server, such as application server 100 illustrated in FIG. 1. The most important elements of such server are logic components for user authentication 105, state handling 110, aggregation of fragments 115, a plurality of portlets 120 provided in respective pages 125 with a respective plurality of APIs 130 to a respective portlet container software 135 for setting the portlets 120 into the common page context, and portal storage resources 140. The logic components are operatively connected such that data can be exchanged between single components as required as represented in FIG. 1.

The existing art portal realizes a request/response communication pattern, i.e., it waits for client requests and responds to those requests. A client request message includes a URL/URI which addresses the requested portal page and/or other portal resources.

More specifically, an existing art portal such as illustrated in FIG. 1 implements an aggregation of portlets 120 based on the underlying portal model 150 comprising a hierarchy of portal pages that may include portlets and portal information such as security settings, user roles, customization settings, and device capabilities. Within the rendered page, the portal automatically generates the appropriate set of navigation elements based on the portal model. The portal engine invokes portlets during the aggregation as required and when required and uses caching to reduce the number of requests made to portlets. The existing art WebSphere™ portal by IBM™ employs open standards such as the Java™ portlet application programming interface (API). It also supports the use of a remote portlet via the Web Service for Remote Portlets (WSRP) standard.

Referring again to FIG. 1, the portlet container 135 is a single control component competent for all portlets 120, which may control the execution of code residing in each of these portlets. It provides the runtime environment for the portlets and facilities for event handling, inter-portlet messaging, and access to portlet instance and configuration data, among others. The portal resources 140 are in particular the portlets 120 themselves and the pages 125 on which they are aggregated in the form of an aggregation of fragments and the navigation model. A portal database 128 stores the portlet description, which details the portlet description featuring attributes such as portlet name, portlet description, portlet title, portlet short title, and keywords. The portal database 128 also stores the content model 150 which defines the portal content structure, i.e., the structure of pages and comprises page definitions. A page definition describes a portal page and references the components (e.g. portlets) that are contained in the page. This data is stored in the database 128 in an adequate representation based on existing art techniques such as relational tables.

Referring further to FIG. 1, some existing art portals contain a navigation component 165 which provides the possibility to nest elements and to create a navigation hierarchy, which is stored in the portal model.

Referring once more to FIG. 1, an important activity in existing art rendering and aggregation 115 processes is the generation of URLs that address portal resources, e.g., pages 125. A URL is generated by the aggregation logic and includes coded state information. The aggregation state as well as the portlet state is managed by the portal. The aggregation state can include information such as the current selection including the path to the selected page in the portal model, the portlets modes and states, the portlet render and action parameters, etc. By including the aggregation state in a URL, the portal ensures that it is later able to establish the navigation and presentation context when the client sends a request for the particular URL. A portlet can request the creation of a URL through the portlet API and provide parameters, i.e., the portlet render and action parameters to be included in the URL.

Referring again to FIG. 1, the user repository 129 contains user information and authentication information for each portal user. The user repository may be implemented in a database or a prior art Lightweight Directory Access Protocol (LDAP) directory. The user repository 129 supports various retrieval operations to query information about one user, multiple users or all portal users.

FIG. 2 is a diagram that illustrates an example of existing art interactions in a portal during render request processing. Referring to FIG. 2, a client 220 is depicted at the left side of the diagram with the portlet markup A, B, and C of respective portlets in the client browser. The portal container 135 in the central portion of the diagram and the diverse portlets A, B, and C are depicted at the right side of the diagram. The communication is based on requests which are expressed in the depicted arrows.

Referring further to FIG. 2, in particular, the client 220 issues a render request 260, e.g., for a new page, by clicking on a link displayed in its browser window. The link contains a URL, and in reaction to the user action, the client 220 issues the render request 260 containing the URL. To render the new page, the portal 135 (after receiving the render request 260) invokes state handling, passing the URL. State handling then determines the aggregation state and the portlet state that is encoded in the URL or that is associated with the URL. Typically, the aggregation state contains an identification of the requested page. Aggregation 115 checks if a derived page exists for this user. Aggregation 115 loads the according page definition from the portal database 128 and determines the portlets that are referenced in the page definition, i.e., that are contained on the page. Aggregation 115 sends an own render request 270 to each portlet through the portlet container 135. In the existing art, each portlet A, B and C creates its own markup independently and returns the markup fragment with the respective request response 280. The portal aggregates the markup fragments and returns the new page to the client 220 in a respective response 290.

Referring back to FIG. 1, a graphical user interface component 160 is provided for manually controlling the layout of the plurality of rendered pages. By that interface 160, a portal administrator or user is enabled to control the visual appearance of the portal pages (e.g., by creating new pages and/or by adding or removing portlets on pages). In particular, the administrator or user can decide which portlet is included at a given portal web page by adding portlets to pages or by removing portlets from pages. The manual layout interface 160 invokes the model management 161 which comprises the functionality for performing persistent content model changes and offers an API for invoking this functionality.

Some existing art portals support the concept of page derivation. This concept allows for a stepwise specialization of a page. In the first step, an administrator A creates a page, defines a base layout, and adds content (i.e., portlets) to the page. Thereafter, the administrator grants appropriate rights to other administrators or users, who themselves can derive the page and edit the layout and content of a page, but not any locked elements. When an administrator or a user modifies the page, model management 161 creates a derivation of the page and stores it into the portal database 128. It also stores an association between the implicit derivation and the user that performed the page modification.

For example, assume administrator A creates a page X that comprises portlet A, and administrator B adds portlet B to page X, which results in the creation of the derived page X′. Assume further that user C is authorized to view the page X (and thus X′). In this case, when issuing a request for page X, administrator A will see portlet A (corresponding to page X), administrator B will see Portlet A and B (corresponding to page X′), and user C will also see portlets A and B (corresponding to page X′). Aggregation 115 automatically selects the according page during request processing based on the aggregation state and the ID of the user issuing the request. Now, assume user C modifies the page to include portlet C. The portal thus creates a new derived page X″ and stores it into the database 128. The derived page is associated with user C. When now invoking a request for page X, administrator A will see portlet A, administrator B will see Portlet A and B (corresponding to page X′), and user C will see portlets A, B and C (corresponding to page X″).

There are numerous disadvantages associated with the foregoing existing art portal systems. In such existing art portal systems, users are often searching for information with respect to a certain topic. For example, a user might search for information regarding a certain technology X. There might be several places where information about technology X can be retrieved which makes is necessary for the user to travel many different paths to find the best information sources and to collect what is of interest for the user from those sources. However, it is very difficult to remember all the information sources that were found during the traversal process and even more difficult to remember the routes to those sources.

### SUMMARY OF THE INVENTION

The shortcomings of the prior art are overcome and additional advantages are provided through embodiments of the invention which propose a computer-implemented method for graphical visualization of multiple clickstreams traversed by as user that involves initiating a clickstream session in response to a user log-in and intercepting and storing all navigation interactions of the user during the clickstream session by a clickstream recorder component. In response to the user's request for a visualization of the user's navigation interactions during the session, the stored navigation interactions of the user for the clickstream session are analyzed by a clickstream analyzer to identify segments comprising interconnected nodes sequentially traversed by the user in a single navigation path during the session and to distinguish segments comprising nodes unrelated to other nodes traversed during the session. A graphic depiction of the identified segments comprising the interconnected nodes sequentially traversed by the user in a single navigation path during the session is presented to the user by a clickstream visualizer.

### TECHNICAL EFFECTS

As a result of the summarized invention, technically we have achieved a solution for implementing a method for graphical visualization of multiple clickstreams (i.e., recordings of what a computer user clicks on while web browsing) that have been traversed by users which are presented as thumbnails (i.e., reduced-size versions of images).

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a schematic system view of an example of a portal server implementing an existing art portal;

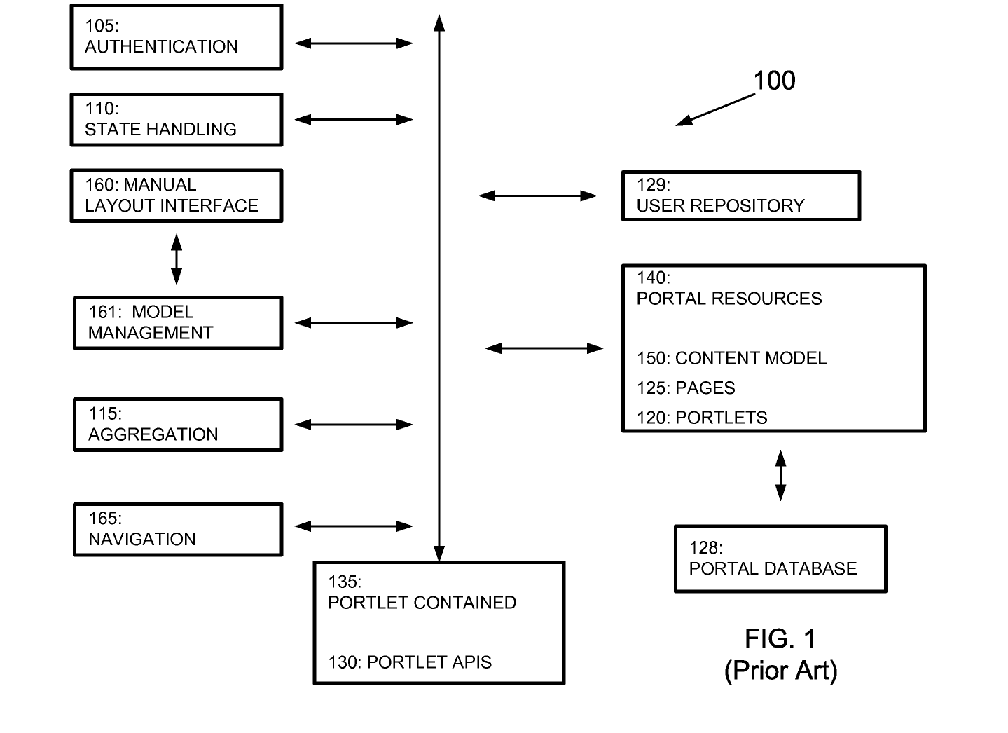

FIG. 2 is a diagram that illustrates an example of existing art interactions in a portal during render request processing;

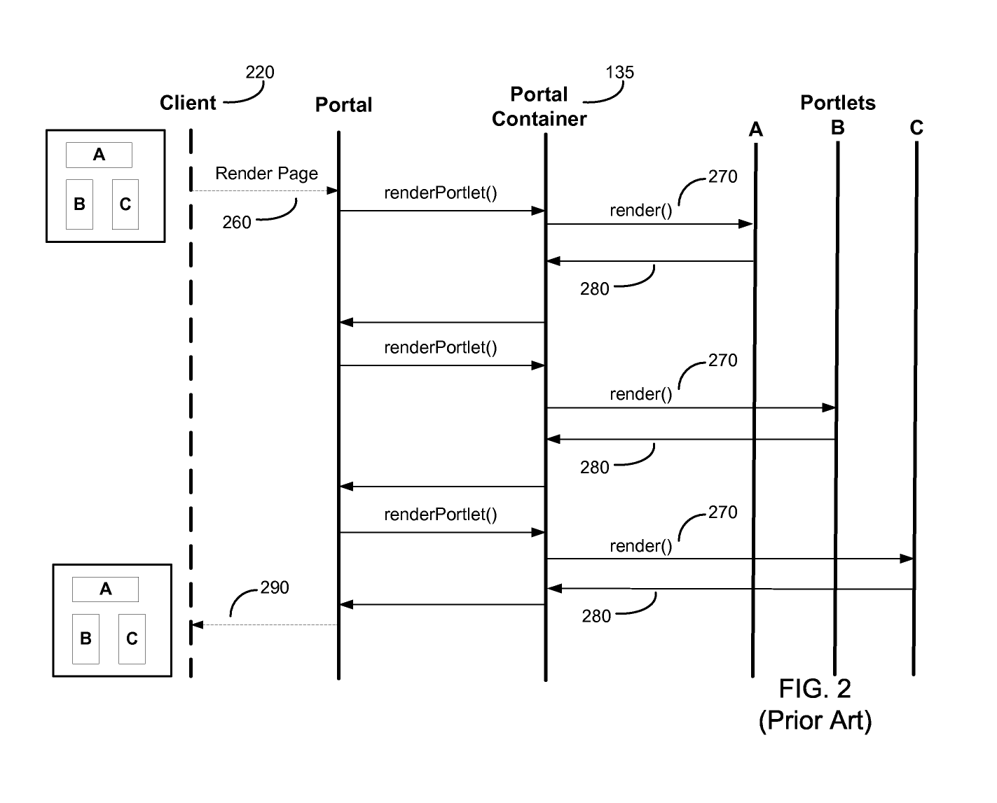

FIG. 3 is a schematic system view of an example of a portal server for embodiments of the invention;

FIG. 4 is a diagram that illustrates an example of a possible visualization presented by the clickstream visualizer 312 to a user; and

FIG. 5 is a diagram that illustrates an example of a general flow for embodiments of the invention.

The detailed description explains the preferred embodiments of the invention, together with advantages and features, by way of example with reference to the drawings.

### DETAILED DESCRIPTION OF THE INVENTION

A focus of embodiments of the invention lies on a graphical visualization of clickstreams (i.e., recordings of what a computer user clicks on while web browsing) that have been traversed by users. In embodiments of the invention, nodes (pages) that have been traversed are presented as thumbnails (i.e., reduced-size versions of images). These thumbnails are clickable screenshots of the nodes that have been traversed during the point in time that they have been traversed. These thumbnails make it easier for users to remember which node provided which information and to decide to where to navigate again when using the clickstream visualizer for embodiments of the invention. The thumbnails are clickable items, and a click redirects the user to the underlying node.

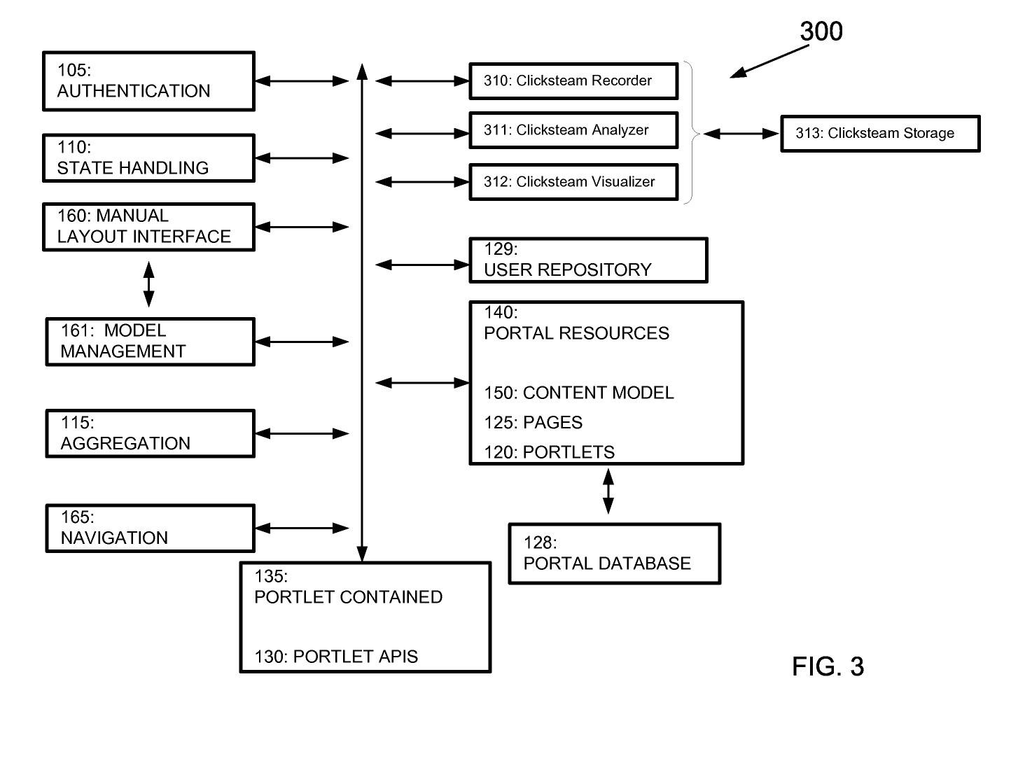

FIG. 3 is a schematic system view of an example of a portal server 300 for embodiments of the invention. Referring to FIG. 3, in embodiments of the invention, the portal is extended by a clickstream recorder component 310. This component 310 tracks each single navigation interaction, such as clicks on pages and portlets, which the user performs. A single clickstream sequence comprises all navigation interactions of a single session. The entire clickstream sequences are stored in clickstream storage 313 for later retrieval.

Referring further to FIG. 3, a clickstream analyzer 311 analyzes the clickstreams. The clickstream analyzer 311 distinguishes between segments that comprise nodes being interconnected and segments that are not related to other nodes already traversed. In addition, the clickstream analyzer 311 analyzes nodes with which users actually interacted and ones which have only been visited.

Referring again to FIG. 3, with the help of a clickstream visualizer 312, the system is at any point in time, able to visualize what has been traversed so far in a graph-like structure. Different segments of interconnected nodes are visualized in parallel, and nodes themselves are represented by thumbnails. The nodes representing real information sources might usually be the dead ends of each single segment. Whether or not they actually are can be determined by observing users' interaction behavior (e.g., copy and paste, etc.). The clickstream visualizer 312 can be invoked by the user on demand. A click on a special link part of the theme redirects the user to a special page on which the clickstream visualizer portlet resides.

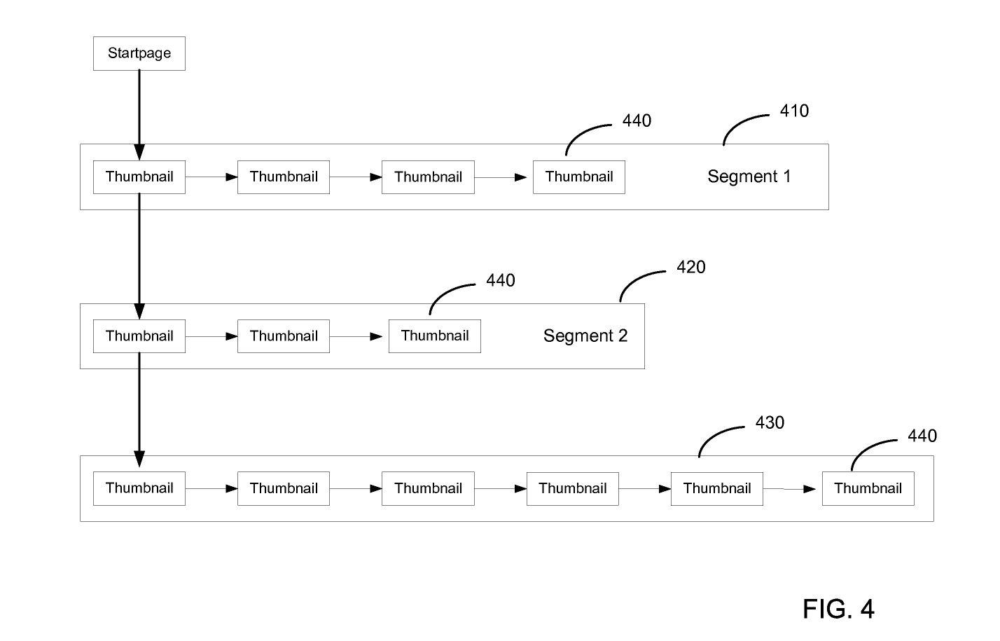

FIG. 4 is a diagram that illustrates an example of a possible visualization presented by the clickstream visualizer 312 to a user. Referring to FIG. 4, three segments 410, 420, and 430 are displayed which represent navigation sequences that belonged together as determined by analyzing timing and navigation patterns. Single segments comprise several pages, each of which is represented by a thumbnail 440 allowing the user to easily remember what the concrete page was about. The thumbnails 440 are clickable, and a click on a thumbnail redirects the user to the underlying page. Thumbnails 440 correspond to real target pages that have previously been determined by the clickstream analyzer 312.

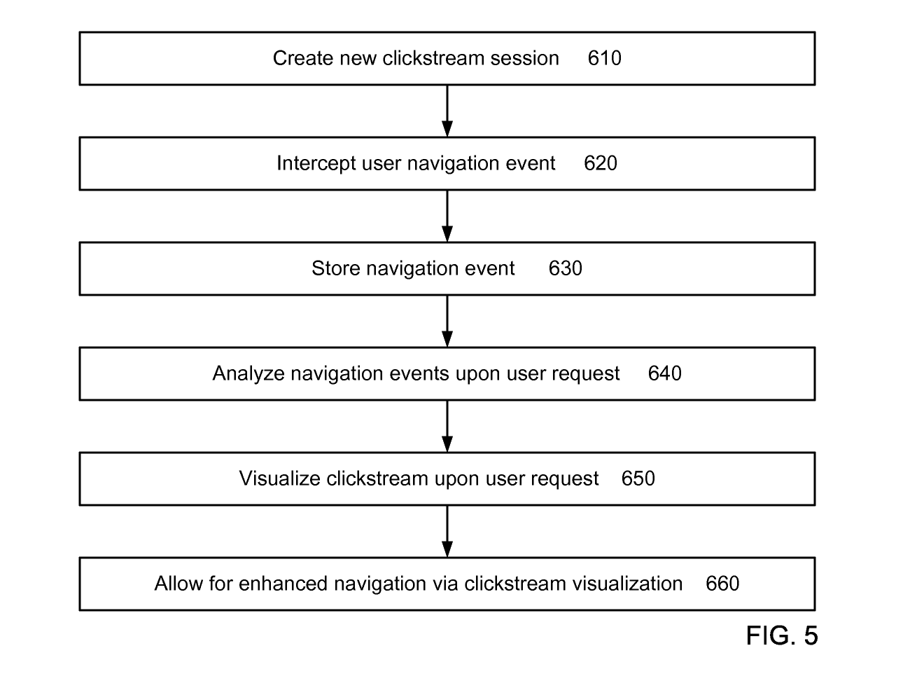

FIG. 5 is a diagram that illustrates an example of a general flow for embodiments of the invention. Referring to FIG. 5, after a user logs in, a new clickstream session is started at 610. Every single navigation interaction is recorded at 620 and stored at 630. Upon receiving the users' request for a visualization of the user's previous navigation behavior, at 640, the clickstream analyzer 312 analyzes the clickstreams to determine segments and real targets, and at 650, the visualizer 312 presents the clickstream to the user.

An important aspect of embodiments of the invention is the recording of every navigation step which a user performs. Embodiments of the invention distinguish between segments, i.e., a list of nodes (pages) that have been sequentially traversed by the user in a way that reveals that the segments belong to one navigation path, which segments comprise nodes being interconnected and segments that are not related to other nodes already traversed. At any point in time, embodiments of the invention enable visualization of what has been traversed so far in a graph-like structure. Different segments of interconnected nodes are visualized in parallel nodes which themselves are represented by thumbnails. The nodes representing real information sources might usually be the dead ends of each single segment, which can be confirmed one way or the other by observing users.

The flow diagrams depicted herein are only examples. There may be many variations to these diagrams or the steps (or operations) described therein without departing from the spirit of the invention. For example, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

1. A computer-implemented method for graphical visualization of multiple clickstreams traversed by a user, comprising:
initiating a clickstream session in response to a user log-in;
intercepting and storing all navigation interactions of the user during the clickstream session by a clickstream recorder component;
analyzing the stored navigation interactions of the user for the clickstream session by a clickstream analyzer in response to the user's request for a visualization of the user's navigation interactions during the session to identify segments comprising interconnected nodes sequentially traversed by the user in a single navigation path during the session and distinguishing segments comprising nodes unrelated to other nodes traversed during the session; and
presenting to the user by a clickstream visualizer a graphic depiction of the identified segments comprising interconnected nodes sequentially traversed by the user in a single navigation path during the session, said graphic depiction further comprising different ones of said identified segments of interconnected nodes visualized in parallel, each of which interconnected nodes is represented by a thumbnail screenshot of the node that is clickable to redirect the user to the node represented by the thumbnail screenshot.
